(19) United States
(12) Patent Application Publication
(10) Pub. No.: US 2003/0229857 A1
(43) Pub. Date: Dec. 11, 2003

(54) Apparatus, method, and computer program product for document manipulation which embeds information in document data

(75) Inventors: Hiroyuki Sayuda, Ebina-shi (JP); Norio Yamamoto, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/386,432

(22) Filed: Mar. 13, 2003

(30) Foreign Application Priority Data
Jun. 5, 2002 (JP) 2002-163813
Jun. 20, 2002 (JP) 2002-180518
Dec. 18, 2002 (JP) 2002-366028

(51) Int. Cl. G06F 17/00

(52) U.S. Cl. 715/517

(57) ABSTRACT

A method for document manipulation which embeds additional information in document data in which layout and position of a element have been defined comprises a process of generating rendered image data by rendering a region where additional information is to be embedded in the document, a process of embedding additional information in a part of the rendered image data, and a process of merging a images of the part in which the additional information embedded in the rendered image data with a predetermined region in a original document data.

### BACKGROUND OF THE INVENTION

1. Field of the Invention

The present invention relates to an apparatus, method, and computer program product for document manipulation which embeds predetermined information in document data in which the layout and positioning of elements have been defined.

2. Description of the Related Art

With the development of computers and network technology, electronic documents have become common, with their use and number increasing dramatically in recent years. Notable features of electronic documents include that they can be delivered over a wide range through means such as the Internet or the like and that reference to other information can be easily included by means of hyperlinks or the like.

For example, hypertext, an electronic document, and data of various types linked together to the hypertext can be distributed from a Web server to users through the Internet. In the hypertext, various types of visual information elements included in the hypertext can be linked with other information, referred to by hyperlinks. Specifically, hypertext includes visual information elements such as text, images, and graphics, and the content creator attaches hyperlinks to the visual information elements as desired. When an end user views an HTML document using a Web browser or the like, the user clicks a hyperlinked visual information element, and then the user can obtain the linked data of text, images, sound, and so forth. Hereinafter, description for linking an element with other information in electronically created document data will be referred to as “reference information”, other information liked to the element by the reference information will be referred to as “related information”, linking of an element and related information by reference information, for example, hyperlinks, will be referred to as “reference”. Hypertext content is commonly written in a Hyper Text Markup Language (HTML) or scripting languages of various types, and reference information generally takes the form of a location described by Uniform Resource Locator (URL).

In order to facilitate global distribution of documents through the Internet and make it possible to use documents more conveniently, a technology for maintaining the look of a document across all kinds of computers on which the document is used has been developed. One of the well-known technologies of this kind is a document format the Portable Document Format (PDF). A PDF document is described in a so-called page description language, and layout and positioning of all elements of document data are defined within the PDF document. Consequently, virtually similar display results of the document are obtained on different types of computers for viewing the document. Electronic documents described in PDF and the like can be distributed over the Internet and the like and referenced with software for viewing PDF documents, such as the Adobe Acrobat (Registered Trademark) reader. Therefore, for example, it is easy for Japanese to obtain and view a PDF document described in English and this is practiced widely. Furthermore, the language specifications of PDF are established to enable reference information to attach to a image element. For example, Acrobat (Registered Trademark) supplied by Adobe Systems, a software product for creating PDF documents, provides a function refers to as Web capture which retrieves an HTML document published from a Web server and converts the HTML document to a PDF document. During this process, reference information in the HTML document is incorporated into the PDF document. The user can obtain related information by means of the reference information. Previous inventions concerning the above-described technology are disclosed in the following:

Japanese Patent Laid-Open Publication No. Hei 10-228468,

Japanese Patent Laid-Open Publication No. Hei 10-289239,

Japanese Patent Laid-Open Publication No. Hei 11-203381,

Japanese Patent Laid-Open Publication No. 2001-177712,

Japanese Patent Laid-Open Publication No. 2002-135556, and

Japanese Patent Laid-Open Publication No. Hei 7-121673.

The above-described features of the documents in electronic form are, however, lost when the documents are printed on paper.

In printed documents, only information visible on the display is printed. Description such as reference information which is included in the document data, but not a part of the content of the printed document does not appear on the paper version. For example, suppose that a document includes an “announcement” character string to which reference information on a link to destination is attached so that clicking the “announcement” character string in the displayed document causes the link-to-destination site to send the text describing the announcement content. When this document is printed on paper, the “announcement” character string, in principle, is represented on paper, but the text describing the announcement content and the URL indicating where to find the text are not represented. Therefore, a person viewing the printed document cannot access the site where the “announcement” text exists or obtain know the announcement content.

In order to overcome such problems, technical approaches have heretofore been proposed which embed link information in computer readable form on paper when hypertext content is printed and enable access to related electronic information by optically reading the link information on paper. As an example, first, Japanese Patent Laid-Open Publication No. Hei 10-228468 discloses a system in which reference information linking described information such as text, graphics and so forth having a link with related information at a link to destination is embedded in a predetermined area on a document in the form of two-dimensional bar code and the document is printed. According to this system, when the user access related information at the link to destination, the user must mark the position of the reference information linked with the related information using a marking pen or the like and uses a scanner to scan the document. Then, the system detects the marked position, analyzes the image on the marked position and accesses the related information desired by the user. As a second example, Japanese Patent Laid-Open Publication No. Hei 10-289239 discloses a system wherein means for judging whether the marked position is valid and informing the user of an invalid selection are added to the above system. Japanese Patent Laid-Open Publication No. Hei 11-203381 discloses a system which converts a URL on an HTML document to a two-dimensional coded image, inserts the image following the reference part (the URL part), and prints the document. According to this system, when the user accesses related information at the link to a destination, a camera captures the two-dimensional coded image and the system parses the two-dimensional code, converts it to a URL, and accesses the related information.

For the system disclosed in Japanese Patent Laid-Open Publication No. Hei 10-228468, because the position to be read on the document must be marked with a marking pen or the like, a document which has once been marked can no longer be used. The system disclosed in Japanese Patent Laid-Open Publication No. Hei 10-289239 is improved to inform the user of an invalid selection so that the document has once been marked can be reused. However, the paper document is gradually stained by continual reuse and eventually becomes illegible or damaged to the extent that its presentation to others is undesirable. For the system disclosed in Japanese Patent Laid-Open Publication No. Hei 11-203381, the insertion of the two-dimensional coded image alters the look of the original documents (the positions where the information elements are shown). Accordingly, this system is not applicable to a document for which the layout or look is an important element. Particularly, application to this system is difficult for the document called a clickable map with a plurality of URLs embedded in various positions in the document image. This is because the altered appearance of the document can make it difficult for the user to understand which two-dimensional coded image corresponds to the URL that the user wants to reference.

Fourth, as disclosed in Japanese Patent Laid-Open Publication No. 2001-177712, an image processing apparatus and a medium on which an image is formed which enable embedding information for accessing related information in a visual information element to which the related information is linked without altering the page look of any hypertext content and immediate access to related information are proposed. According to this image processing apparatus, reference information identifying related information is embedded overlapped with a visual information element and, therefore, the page look is not altered by inclusion of the reference information, or altered only slightly. Using this image processing apparatus, for example, by scanning only the visual information element or its surrounding region on the output page and analyzing it, access to information related to the visual information element can be obtained. However, the technique disclosed in Japanese Patent Laid-Open Publication No. 2001-177712 requires a costly, special apparatus for image formation and, because the output of this apparatus is limited to paper documents, a physical delivery method, such as postal mail, must be used to is required for sending output documents to another party and the advantages of electronic documents are lost.

Moreover, the feature of electronic documents that they can be globally disseminated is impaired when they are printed. For example, worldwide dissemination of documents may involve translation from the original language to a foreign language, and use of electronic translation tools enhance this ability There are now available products which performs word-to-word translations using a computerized dictionary and immediately present a translated version of a document on a display screen. However, it is normally impossible to translate printed pages using such a computerized dictionary. Japanese Patent Laid-Open Publication No. Hei 7-121673 describes a technique which can scan printed pages and provide a literal translation to compensate for the above drawback of paper documents. Specifically, barcoded information equivalent to information represented by characters is printed along with text information on the same page. The bar code is scanned by a barcode reader and information represented by characters on paper can be provided as audio information. Thereby, immediate use of electronic information from a printed page of a paper document is made possible, but this is limited to documents with page layout in which bar code positioning was considered beforehand in design. This is not possible for any document obtained through the Internet or other networks.

### SUMMARY OF THE INVENTION

The present invention was devised to address the above circumstances and advantageously provides an apparatus for document manipulation which generates electronic data as document data in which the layout and positioning of elements have been defined, such as, for example, PDF and electronic documents described in a page description language, in a manner such that the electronic data can be printed, preserving reference information and its translatability with a electronic dictionary and the look of a print out document remains the same as the corresponding the document of electronic data. Another advantage provided by the present invention is that it provides an apparatus for document manipulation which can produce document data that can be printed with a common printer, without the use of special equipment.

According to one aspect of the present invention, an apparatus for document manipulation which embeds additional information in document data in which layout and position of a element have been defined is provided. The apparatus for document manipulation comprises means for generating rendered image data by rendering a region where additional information is to be embedded in the document data, means for embedding additional information in a part of the rendered image data, and means for merging an image of the part in which the additional information embedded in the rendered image data with a predetermined region in a original document data.

According to another aspect of the present invention, a method for document manipulation which embeds additional information in document data in which layout and position of a element have been defined is provided. The method for document manipulation comprises a step of generating rendered image data by rendering a region where additional information is to be embedded in the document, a step of embedding additional information in a part of the rendered image data, and a step of merging a image of the part in which the additional information embedded in the rendered image data with a predetermined region in a original document data.

According to a further aspect of the present invention, a computer program product for document manipulation which embeds additional information in document data in which layout and position of a element have been defined is provided. The computer program product when executed by a computer causes the computer to execute a step of generating rendered image data by rendering a region where additional information is to be in the document, a step of embedding additional information in a part of the rendered image data, and a step of merging a image of the part in which the additional information embedded in the rendered image data with a predetermined region in a original document data.

### BRIEF DESCRIPTION OF THE DRAWINGS

FIG. 1 is a block diagram showing a configuration of an apparatus for text manipulation according to a preferred embodiment of the present invention.

FIG. 2 is a block diagram showing example program implementation functions to be performed by the apparatus for text manipulation of the preferred embodiment of the invention.

FIG. 3 illustrates an example of setting information.

FIG. 4 illustrates examples of positions where embedding is performed.

FIG. 5 illustrates merging embedded object forms with figures from original text data.

FIG. 6 is a flowchart illustrating an example operation sequence of the apparatus for text manipulation of the preferred embodiment of the invention.

FIG. 7 is a block diagram showing another example of a suite of program implementation functions to be performed by the apparatus for text manipulation of the preferred embodiment of the invention.

FIG. 8 illustrates undesirable embedding in which two embedded objects overlap each other.

FIG. 9 illustrates undesirable embedding in which part of an embedded object runs off the edge of a page.

FIG. 10 is a block diagram showing a further example of program implementation functions to be performed by the apparatus for text manipulation of the preferred embodiment of the invention.

FIG. 11 is a flowchart illustrating an example operation sequence in which the program implementation functions shown in FIG. 10 are performed.

FIG. 12, which is comprised of FIGS. 12A through 12D, illustrates an example of extraction of English words.

FIG. 13, which is comprised of FIGS. 13A through 13C, illustrates pasting visual information in different positions.

### DESCRIPTION OF PREFERRED EMBODIMENT

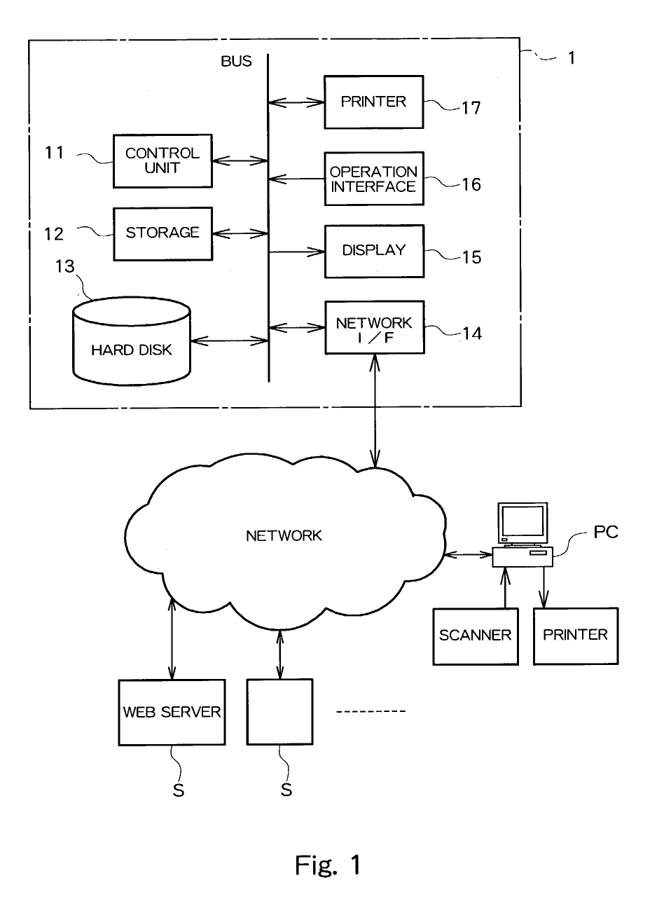

The present invention will now be described in detail with reference to the accompanying drawings in which a preferred embodiment of the invention is illustrated. First, a document manipulation apparatus 1 according to the preferred embodiment of the present invention is shown in FIG. 1. As shown in FIG. 1, the document manipulation apparatus 1 comprises a control unit 11, storage 12, hard disk 13, network interface (I/F) 14, display 15, operation interface 16, and printer 17 and connected to Web servers S via a network. Document data created by the document manipulation apparatus 1 is transferred to the Web servers S as appropriate. In FIG. 1, a personal computer PC is also connected to the network. A scanner and a printer are connected to the personal computer PC. Software such as a browser for viewing documents provided by the Web servers S and software for viewing PDF documents are installed on the personal computer PC such that the user of the personal computer PC may receive electronic documents distributed via the network from the Web servers S and views them with the browser and other software.

The control unit 11 of the document manipulation apparatus 1 implements the means provided on the document manipulation apparatus of the present invention by executing programs installed on the hard disk 13. The control unit 11 operates under the control of an operating program stored in the storage 12 as the working memory and primarily executes a process of generating rendered image data by rendering a region where additional information is to be in the document data, means for embedding additional information in a part of the rendered image data, and means for merging a image of the part in which the additional information embedded in the rendered image data with a predetermined region in a original document data. For example, reference data, information identifying a word, and so forth may be embedded. The embedding-related process and the content of the embedded data will be described in detail below. The hard disk 13 is a computer readable recording medium which can store programs to be executed by the control unit 11. If a drive, which is not shown, for accessing an external computer readable recording medium, for example, a CD-ROM or DVD-ROM, is used, a wide variety of programs can be installed from this kind of medium to the hard disk 13. As will be described later, the functions of the present invention can generally be implemented by the programs installed on the hard disk 13. However, this is only an example; the programs for implementing the present invention may, for example, be stored in another type of medium or downloaded through a communication line when necessary.

The network interface 14 is means for connecting the document manipulation apparatus 1 to the network. Under command of the control unit 11, the network interface 14 sends a request to a Web server S via the network, receives data in reply to the request, and supplies the received data to the control unit 11. The display 15 displays a document (As used herein, “document” includes image files and the like) in response to a command issued from the control unit 11 and based on the document data to be displayed. The operation interface 16, such as a keyboard, mouse, or the like, conveys a signal generated by user operation and corresponding to a command from the user to the control unit 11. The printer 17, by a command from the control unit 11, prints a document on paper by general means of electrophotographic process, inkjet or the like. While the printer is shown directly connected to the bus in FIG. 1, the printer may be connected via a Universal Serial Bus (USB) or the like, or via the network. The Web servers S are of a common type that is generally known and, therefore, explanation of the servers is not given.

The present invention can be carried out in the environment of the network configuration and the apparatus configuration shown in FIG. 1. In one example of the present invention, reference information is embedded. In another example, word identifying information is embedded. First, a procedure for embedding reference information and a structure of program functions for the procedure will be explained.

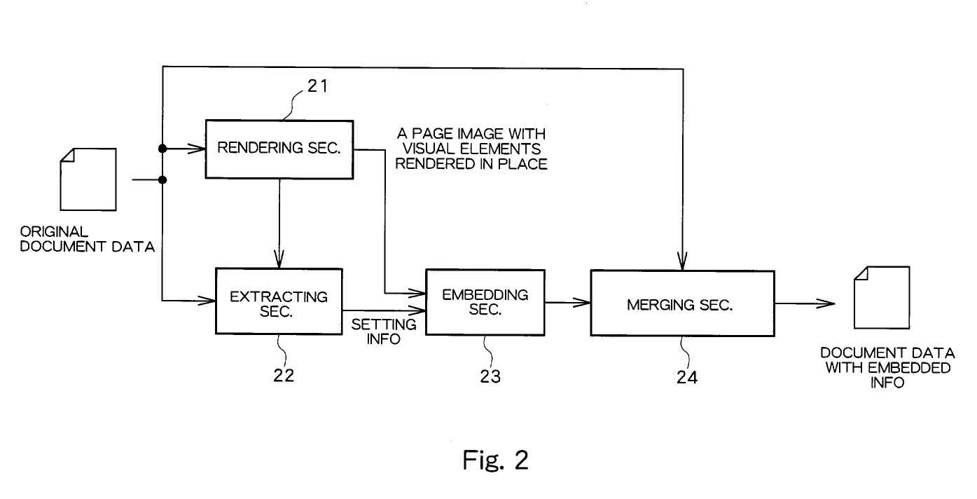

For embedding reference information, a single program or a plurality of programs providing a structure of functions which are, for example, as shown in FIG. 2 are installed on the hard disk 13 and executed by the control unit 11. In FIG. 2, the program implementation functions, namely, a rendering section 21, a extracting section 22, an embedding section 23, and a merging section 24 are shown. In the present embodiment, these functions are performed together so that additional information is embedded in input document data. Document data to be input is a document comprising, generally, a plurality of visual information elements (such as graphics and text), for example, an HTML document or PDF document. In the following, to make explanation as realistic and easy to understand as possible, document data described in a page description language, for example, PDF-format document data is assumed to be input. However, the method of embedding reference information according to the present embodiment of the invention is applicable to other formats of documents, provided that the layout and position of the elements of the document data have been defined and the document format allows for attaching reference information to any element.

First, the rendering section 21, among the functions shown in FIG. 2, renders document data and converts it to rendered image data in bitmap form. Specifically, the rendering section 21 arranges the element included in the document data in their predefined layout and positions and coverts them to bitmap data.

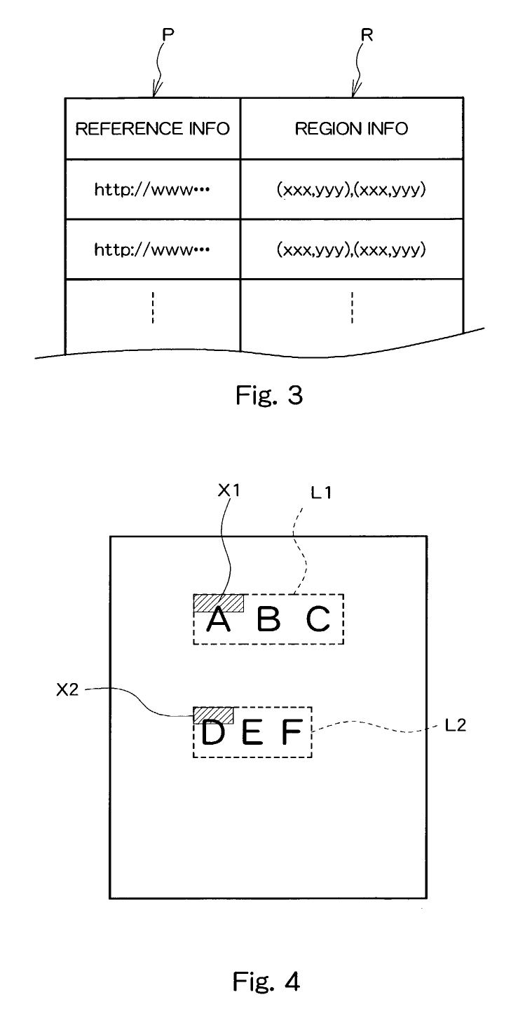

The extracting section 22 then extracts reference information from the document data. When extracting reference information, the extracting section 22 also obtains information indicating where the reference information should be embedded within which region on the rendered image data, associates each reference information with the obtained information, and outputs the associated information as setting information. Specifically, the setting information output from the extracting section 22 is in the form of a list as shown in FIG. 3. In this list, each reference information (P) extracted from document data is associated with the region information (R) indicating the region which is, for example, represented by coordinates where the element rendered at the rendering section 21 should be attached to the reference information. For example, the region information (R) may be specified by the coordinates of the upper left point and the lower right point of a rectangle included in the region where the element corresponding to the reference information is rendered. Although in the following explanation, region information (R) is assumed to be a rectangular region for simplification, the region information is not restricted to a rectangle.

The embedding section 23 receives the rendered image data and the setting information, and embeds the reference information included in the setting information in the appropriate region on the rendered image data in order to generate embedded image data. The appropriate region to be embedded with the reference information can be specified by referring to the setting information associated with the reference information. Embedding may be performed, using the embedding method disclosed in Japanese Patent Laid-Open Publication No. 2002-135556 noted above. When the area where reference information is actually embedded is unequal to the region specified in the list table, for example, as shown in FIG. 4, reference information is embedded within smaller rectangular regions X1 and X2 including the coordinates of the upper left points of rectangular regions L1 and L2 specified in the list table. The embedding section 23 extracts a region including the area where reference information was embedded and outputs it together with the setting information associated with the reference information. The size of the region to be extracted may be equal to the area where reference information was embedded.

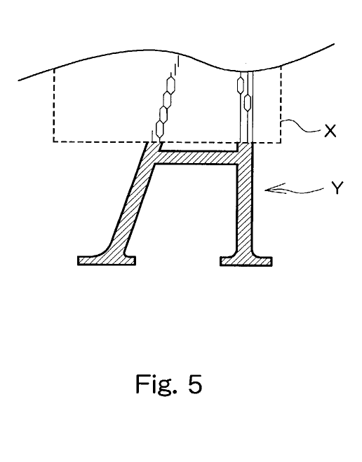

The merging section 24 receives the images of the areas where each reference information was embedded (hereinafter referred to as “embedded object images”), region information (R) indicating the regions of the embedded object images, and the original document data for which embedding was performed, from the embedding section 23, and merges each embedded object image into the original document data in position corresponding to its region specified by the region information. Specifically, for document data such as PDF in which the layout and position of all elements have been defined, a region corresponding to the rectangular region where embedding should be performed can be clearly specified on the rendered image data. Thus, the embedded object images may be merged in such a manner that they are overwritten to the original document data in the positions corresponding to the rectangular regions specified. When the thus obtained image is printed, the result will be as is shown FIG. 5 wherein smoothly drawn figures Y according to the PDF descriptions are merged with bitmap figures X in which reference information was embedded after being rendered. Because the edges are visually seamless, the print does not give the user an impression that anything was embedded in the original.

In aspects of implementation of the present invention, the program implementation functions shown in FIG. 2 can be provided as a plug-in (an additional program for function extension) for the Adobe Acrobat (registered trademark) software. In such a case, under the control of software for creating and viewing PDF files, when the control unit 11 detects a command input through the operation interface 16 to execute the above-described programmed processes from the user who is creating or viewing a PDF file, the control unit executes the above processes for each page of document data.

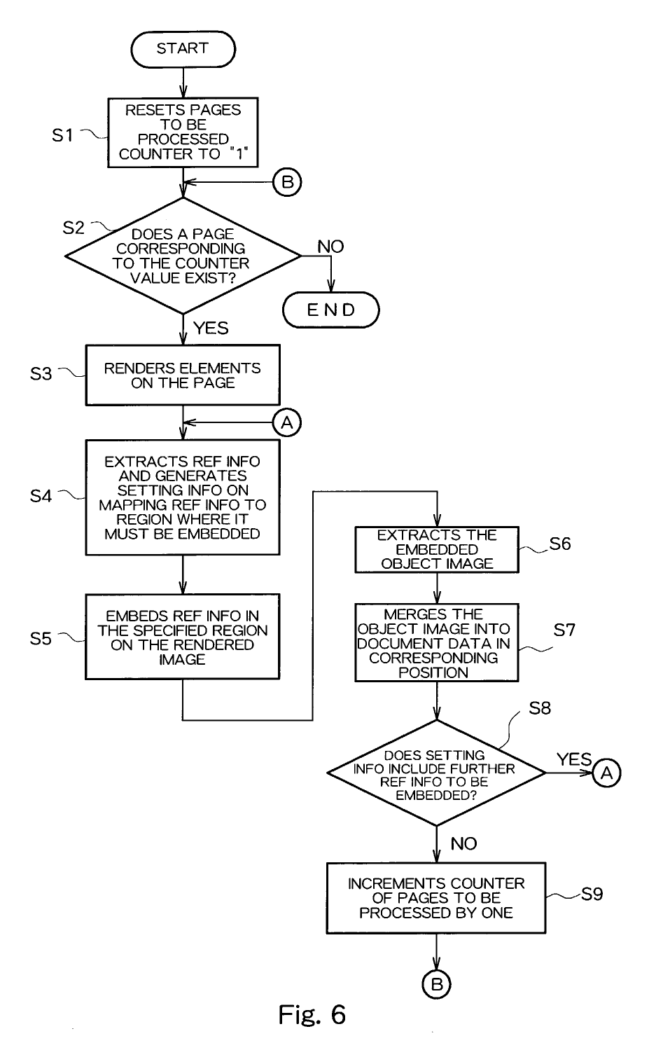

When the present invention is carried out in this aspect of implementation, upon the detection of the input command to execute the programmed processes shown in FIG. 2 for, for example, document data to be processed, the control unit 11 starts a process sequence which is shown in FIG. 6. The control unit 11 resets the counter of pages to be processed to “1” (S1). The control unit 11 determines whether a page corresponding to the value of the above counter exists (whether all pages have been processed) (S2). If no page to be processed exists (all pages have been processed), the process terminates. At step S2, if a page to be processed exists, the control unit 11 renders the document data of the page, thus generating the rendered image data corresponding to the page (S3), and stores it into the storage 12. The control unit 11 then extracts reference information from the document data of the page to be processed and associates the reference information with the region information (R) indicating the region which is where the element rendered at the rendering process should be linked to the reference information, and then generates setting information (S4). The setting information is also stored in the storage 12. Referring to the setting information, the control unit 11 embeds reference information in the specified region on the rendered image data generated in step 3 and buffered in the storage 12 (S5). The control unit 11 extracts the image in the region wherein the reference information is embedded as the embedded object image (S6), and then the embedded object image is merged into the image in the corresponding region on the original document (S7) The control unit 11 determines whether the setting information includes further reference information to be embedded (S8). If so (reference information being yet to be embedded exists), the control unit 11 returns to step S5 to embed the reference information (A). If reference information being yet to be embedded does not exist at step S8, the control unit 11 increments the counter of pages to be processed by one (S9), returns to step S2, and continues the process.

In the above operation sequence, after creating rendered image data by rendering whole document data, reference information is embedded. It is also possible to generate setting information before rendering and, based on the setting information, render only elements for which embedded object images must be generated to thereby generate partial rendered image data, The reference information included in the setting information is embedded in the partial rendered image data to generate the embedded object images, and then merge the embedded object images into the original document data.

According to the present embodiment, from document data such as a PDF in which the layout and positions of the elements have been defined, the elements are converted to bitmap objects or the like for which embedding can be performed to obtain a rendered image data. For each element to which reference information is to be embedded, the reference information is embedded in the specified region on the rendered image data. The rendered image data are imposed in the PDF descriptions. The embedded information is merged into the PDF document so that they are rendered in the same positions where they were embedded on the rendered image data when the PDF is rendered. Consequently, when the document data is viewed or printed, the boundaries between the embedded objects and the original figures appear to be natural. If, for example, fonts used in a PDF document are not installed on a computer used to view the document, the layout and positioning of the elements of the document may deviate to some extent. In this case, the boundaries between the embedded information and the original figures have somewhat unnatural appearance. Thus, it is preferable for PDF files to perform font embedding when creating a PDF to include font data to be used in creation of the PDF document data. This ensures that rendered visual elements do not change even if specific fonts are not installed on the computer for viewing PDF documents. Documents such as HTML documents for which the layout and positions of the elements are not defined should be converted to PDF documents for which the layout and positions of the visual information elements have been defined before the above-described processes are performed.

Then, the use of document data with embedded information generated through the process of the present embodiment will be described. The document data can be transmitted via the network as electronic data, received by a personal computer PC or the like connected to the network, and presented on the display. Even when the document data is shown on the display, the user can retrieve and view related information by selecting electronic reference information included in it by appropriate operation. When the user prints the document data with a common printer, such as a common electrophotographic or inkjet printer or the like, the document including embedded information is printed. The user can select a preferred embedded object image included in the print medium and have it scanned optically by a scanner or the like. Then, the personal computer extracts the reference information embedded in the embedded object image and performs predetermined action with the reference information (for example, obtains and presents related information, using the URL as the reference information).

In another aspect of embodiment of the present invention, identifiers are used. In the above-described embodiment, reference information is directly embedded in document data as additional information. If the reference information consists of an extremely large amount of data, the size of the embedded object image will be so great that problems may result such as, for example, when a number of reference information must be embedded in mutually close positions. To avoid such a problem, it is preferable to assign identifiers to reference information, retain a database of mapping between reference information and an identifier, and embed the identifiers in document data as additional information. In this aspect, when the additional information is used, an identifier specified by the user is read and the database should be referenced to look for the reference information mapped to the identifier.

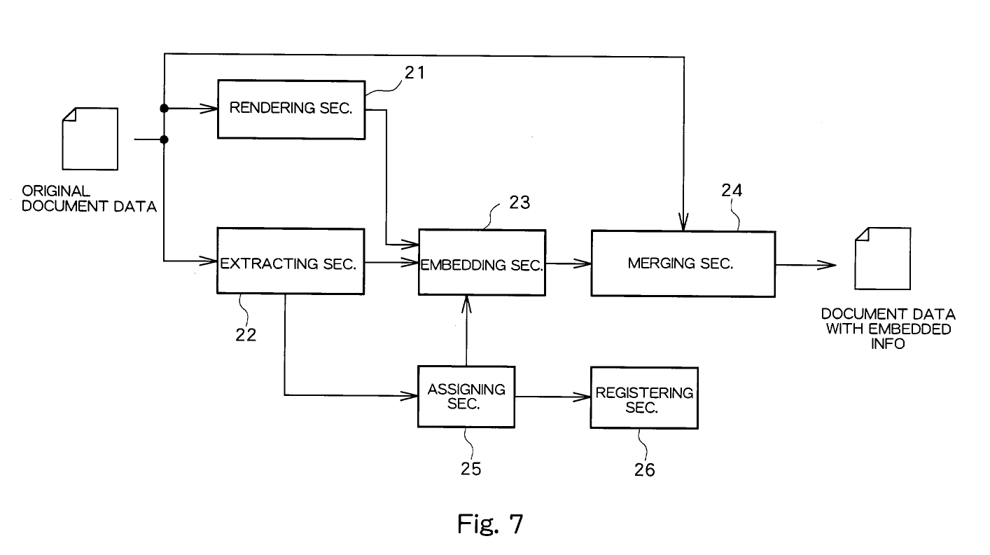

Specifically, program implementation functions for embedding information for this aspect of embodiment which differ from those shown in FIG. 2, are a rendering section 21, a extracting section 22, an embedding section 23, a merging section 24, a assigning section 25, and a registering section 26, which are shown in FIG. 7. In FIG. 7, the function sections assigned the same reference numbers as shown in FIG. 2 operate in the same way and provide the same functions as those shown in FIG. 2 and, therefore, their explanation is not be repeated. Among the function components shown in FIG. 7, the assigning section 25 assigns a unique identifier to each reference information extracted by the extracting section 22 and outputs information indicating correlation between the identifier and the reference information as registration information. The identifiers may be, for example, serial numbers, each consisting of four bytes. The registering section 26 receives the registration information from the assigning section 25 and stores that information on the hard disk 13, thus creating the database of mapping between reference information and an identifier on the hard disk 13. The embedding section 23 receives the registration information and embeds the identifier mapped to the reference information in the specified region on the rendered image data, instead of the reference information.

In this example, when the control unit 11 receives via the network through the network interface 14 an identifier and a request for reference information mapped to the identifier, the control unit 11 searches the registration database stored on the hard disk 13 in response to this request and sends back the reference information mapped to the specified identifier to the request sender. According to this embodiment, objects of equal size are embedded, using fixed length identifiers and this facilitates processing such as, for example, in-advance extracting regions where information is to be embedded (rendering elements only in these regions).

In this example, a personal computer PC on which document data with embedded information is used operates as follows. When the user prints the document data with a an ordinary printer, such as an electrophotographic or inkjet printer or the like, the document is printed in a form including embedded object images. The user can select a preferred embedded object image included in the print and have it scanned optically by a scanner or the like. Then, the personal computer PC gets the identifier included in the embedded object image and requests the document manipulation apparatus 1 to retrieve reference information mapped to the identifier. In response to the request, the control unit 11 of the document manipulation apparatus sends back the reference information mapped to the identifier to the personal computer PC, which then performs predetermined action with the reference information, such as, for example, retrieving and displaying related information, using the URL as the reference information.

While the database of mapping between reference information and an identifier is stored on the hard disk 13 of the document manipulation apparatus 1 in this embodiment, it is also possible to distribute the database as a database file containing identifiers mapped to reference information with document data with embedded information so that the personal computer PC can refer to the database file. Alternatively, such a database may be stored on a server not shown and the personal computer PC may to retrieve from the server the reference information mapped to a detected identifier.

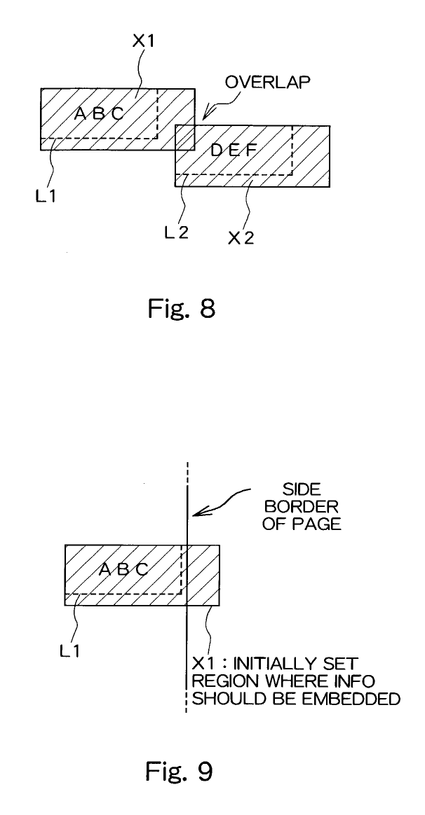

Meanwhile, regardless as to which of the processes shown in FIG. 2 and FIG. 7 are executed, the size of embedded objects which occupy a given area may exceed the region where the link of reference information corresponding to each embedded object image is present on an original document page. For example, two embedded object images may overlap each other as is shown in FIG. 8. In order to avoid the overlap in such cases, it is preferable to exert control of embedding so that either embedded object image is not merged. If two embedded object images overlap, one of the embedded object image which was generated later in the process sequence should not be merged. In this case, it is also preferable that the embedded object image that should not be merged in area be moved to another suitable area on the document data; for example, in a margin of printing image of the document data. Alternatively, such embedded object image should be moved to the suitable position in the neighboring of its original position, or, in other words, near the region where it should be merged, specified by region information in setting information, provided that it does not overlap another embedded object image when being printed. This embedding control (not to merge an embedded object image that overlap a previously embedded object image into the document data or move it to a suitable position near its original position where it should be embedded) is applicable to cases wherein part of an embedded object image runs off the edge of the page when being printed, such as is shown in FIG. 9.

Although in the example described above the embedded object image is directly merged as the image, the embedded object image may be converted to another type of element or elements such as characters, figures, or the like and merged with them. If original document data consists of a plurality of layers (document elements), it may also be preferable to place an embedded object image on a layer different from the layer on which the visual information element to which the embedded object pertains is described in the original document data.

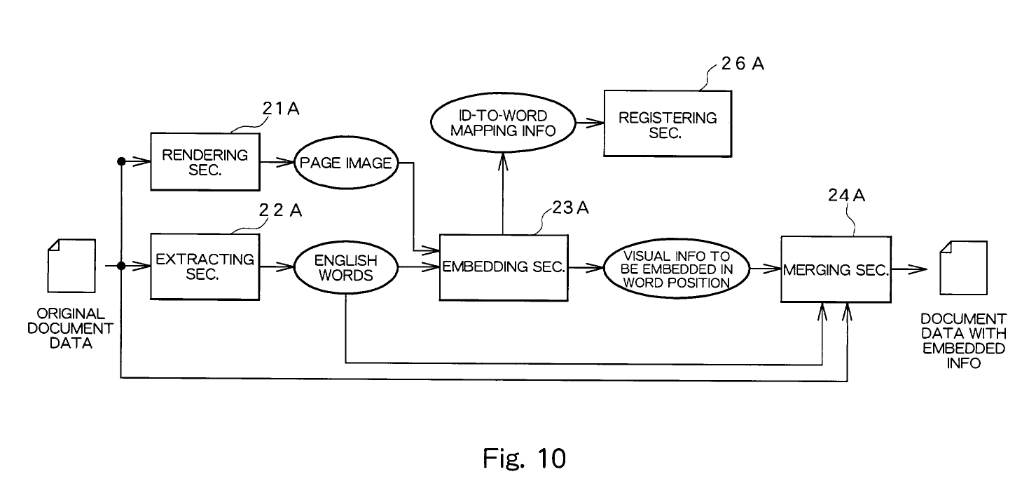

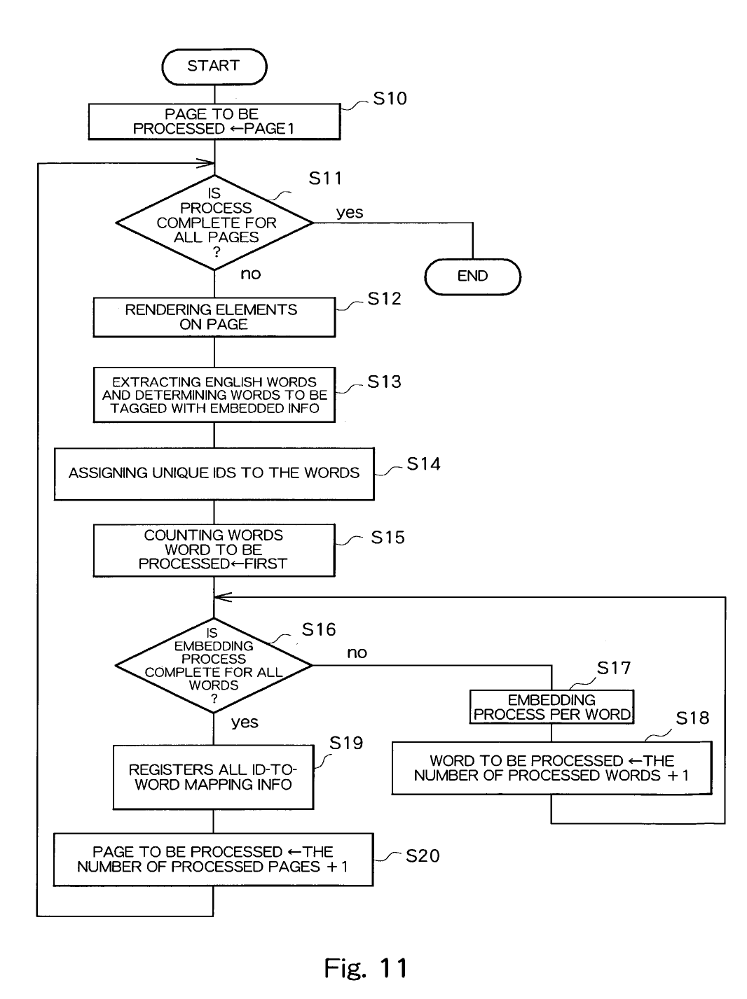

In a further aspect of implementation of the present invention, information identifying words is embedded. In the example environment of implementation shown in FIG. 1, an embodiment of the invention in which information identifying words is embedded and a computerized dictionary is used will be described below. In this embodiment, the document manipulation apparatus manipulates a PDF document written in English, using a structure of functions which are shown in FIG. 10 and following a process flow which is shown in FIG. 11. FIG. 10 shows a structure of functions provided by a single program or a plurality of programs, which are installed on the hard disk 13 and executed by the control unit 11. FIG. 11 shows a procedure of executing the processes corresponding to the above functions which are provided in plug-in software. The present invention according to this embodiment as well as the foregoing embodiments can be carried out in different environment, structure of programmed functions, and process flows from those shown in FIGS. 1, 10, and 11, provided that its essence does not change.

In FIG. 10, original document data to be processed may be, for example, a PDF document described in a page description language, each page consisting of elements to be drawn, such as text, figures, images, and images. A rendering section 21A renders visual objects from the document data consisting of the elements and generates a page image with elements rendered in place. An extracting section 22A extracts an English word and its position from the character elements included in the original document data and identifies the English word to be processed in the following stage. A embedding section 23A generates information embedded image and ID-to-word mapping information based on the English word for which information should be embedded, identified by the extracting section 22A and the image in the position of the English word on the page image (rendered image) generated by the rendering section 21A. A pasting section 24A pastes the information embedded image generated by the embedding section 23A at the position of the English word on the original document data by overwrite. In other words, the information embedded image is embedded into the document page by merging, thus generating embedded document data with embedded information identifying English words, that is, embedded information which enables automatic translation by referring to a computerized English dictionary. By printing this embedded document data (more exactly, rendering again to print the embedded document data), a paper document can be obtained in which embedded information and its surrounding are visually seamless and which has information which enables automatic translation by referring to a computerized English dictionary. That is, a printed document in which information identifying words was embedded and which do not give the user impression that something was pasted to the original is obtained. The user can understand the meaning of a word by scanning the image of the embedded information identifying the word with a handy scanner or the like. The information identifying the word is decoded and conveyed to a computerized English dictionary. And the definition of the word can be returned immediately. A registering section 26A registers the ID-to-word mapping information generated by the embedding section 23A so that the information can be referenced when the word on a paper document is actually scanned for reference to the computerized English dictionary. This database may be installed on a device on the network or on the document manipulation apparatus 1.

Referring to FIG. 11, the process flow will be explained. In the procedure shown in FIG. 11, the process is sequentially performed for each page of original document data. Initially, page 1 of original document data is set for the page to be processed (S10) and, whenever the process for one page is completed, the next page is set for the page to be processed (S20). Steps S12 through S19 are performed repeatedly until the process is completed for all pages (S11).

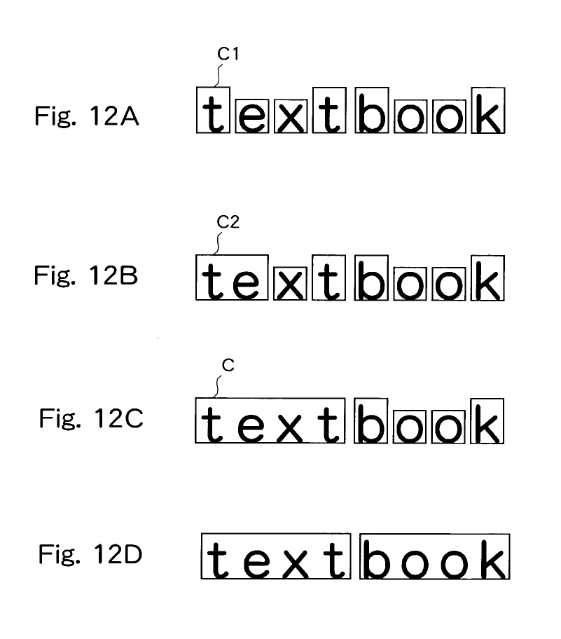

Among these steps that are repeated for each page, step S12 is performed by rendering section 21A. For elements such as text, figures, and images on the page to be processed, visual objects are rendered and drawn, using the storage 12 (memory), and a page image with the visual objects rendered in place is generated. The next step S13 is performed by executing the extracting section 22A. English words are extracted from the original document data and the words to be processed in the following stage are identified, according to preset conditions, and the attributes of the identified words are stored for future use. English words can be extracted in a manner which is, for example, illustrated in FIG. 12. In FIG. 12, the English word “textbook” is assumed included in original document data and, by determining minimum rectangles and determining whether successive rectangles should be concatenated, the word can be extracted.

Characters such as English letters are normally represented in original document data as character elements. According to the format and representation manner of the original document data, character elements may be rendered in units of character blocks or strings or in units of single characters. In this embodiment, characters are assumed to be rendered in units of single characters as the elements. First, determine minimum rectangles C1 enclosing each character element (FIG. 12A). Then, focus attention on a character (focused character) and find a candidate character to be connected to the focused character. In the example shown, the first letter “t” is the focused character and the next letter “e” is a candidate character in spelling. The extracting section 22A compares the distance between two minimum rectangles respectively enclosing the focused character and the candidate character with a predetermined distance and determines that the two rectangles should be concatenated if the distance is less than the predetermined distance. The predetermined distance by which concatenation is determined should be set smaller than the distance between two words. For example, if the distance between two rectangles is greater than the width of the second character which is a candidate to be connected to the first character, it should be determined that the rectangles should not be concatenated, that is, the two characters do not form a same word. In the example shown, because the distance between the minimum rectangles of the characters “t” and “e” is smaller, it is determined that both should be concatenated as the two ones of the characters forming a same word and these minimum rectangles are concatenated and a rectangle C2 enclosing the two characters is formed (FIG. 12B). Through repetition of determination as to whether or not two successive rectangles are to be concatenated based on the distance between them, a rectangle C enclosing a string “text” is formed (FIG. 12C). However, because the distance between the next candidate character “b” and the focused character string “text” is greater, the rectangles in this example are not concatenated. That is, this gap is regarded as spacing between one word and another word and a word “text” is detected. Because determining whether to concatenate two successive rectangles by the distance between them is further repeated, separate rectangles respectively enclosing “text” and “book” are formed (FIG. 12D). That is, two separate words “text” and “book” are detected. In step S13, by detecting concatenated characters and spacing in the manner described above for all characters on the page to be processed, words present on the page are extracted with their position and size identified.

From among the thus extracted English words, words to be tagged with information which is generated by the embedding section 23A are determined by the extracting section 22A in step S13. The extracted English words include words for which it is anticipated that information embedded in the word position may overlap another information embedded image or run off the page edge. Such words, that is, the words for which it is physically impossible to embed information are excluded from those to be processed at this stage. Among the English words, some should be or preferably must be tagged with embedded information, that is, for which reference to a computerized dictionary may be required, others should not. Thus, the latter are excluded from those to be tagged with embedded information. Actually, because different people will have different vocabularies and purposes, exact and logical distinction between words to be tagged with embedded information and may be impossible. Such distinction should be performed to exclude low priority words, according to generally acceptable conditions and manners. The following process may, for example, be performed:

(1) Make a list of English words which are so common that most people can understand the meaning of the word and exclude words found in this list.

(2) Make a list of English words which are considered difficult for most people to understand and include words found in this list in those to be tagged with embedded information.

(3) A word consisting of characters more than a predetermined number of characters (for example, five) should be included in those to be processed.

(4) For repeated words on a same page, one appearance should be selected to be tagged with embedded information.

According to these conditions, it is preferable to limit the number of words to be tagged with embedded information. More preferable, a combination of these conditions should apply (for example, conditions (1), (2), and (3) should apply. Limiting the number of words to be processed by the above steps (1) to (4) may be effective for cases where an English-Japanese dictionary to be used by the users is unknown beforehand. If an English-Japanese dictionary to be used is known beforehand, a condition that words not found in this dictionary should be excluded can apply solely or in combination of the above conditions.

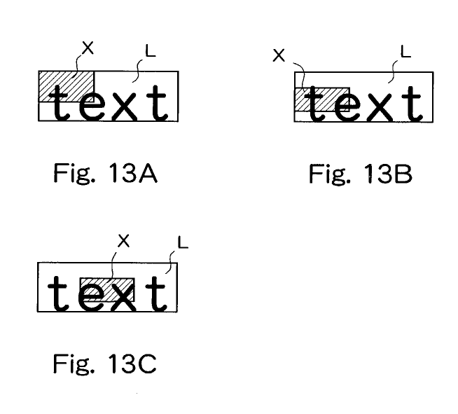

The embedding section 23A then assigns unique IDs to the English words selected as those to be tagged with embedded information (S14). These IDs can identify the English words. The IDs are actually embedded in place into the document data and the English words can be identified by reference to the ID-to-word mapping information. The embedding section 23A and the pasting section 24A perform generating information embedded image in word position, embedding the information embedded image in place into the original data, and generating IP-to-word mapping information (S17) for the English words assigned the IDs sequentially (S15, S18) and for all the English words to be tagged with embedded information on the page to be processed. Specifically, the embedding section 23A first obtains the attributes of an English word to be tagged with embedded information (position, size, and English word) from the extracting section 22A. The “position” may be, for example, the coordinates of an upper left point of the rectangle enclosing a word. The “size” is not the size of the word in the original document data, but is the width and height of the region where the information embedded image is to be embedded. Based on the “position” and “size,” the embedding section 23A removes the information is to be embedded from the page image generated by the rendering section 21A. The embedding section 23A inserts the information to be embedded, that is, the ID of the English word to be tagged into the clipped region, thus generating information embedded image at the word position. The pasting section 24A pastes the information embedded image into the word position in the original document data in the original position of the English word by overwriting the data. The information can be pasted in different positions, as illustrated in FIGS. 13A through 13C. For example, in FIG. 13A, the pasted information falls within a smaller rectangular region X with the same upper left point as the rectangle L enclosing the word. The information embedded image in the word position can be pasted without modification to the element to be drawn in the corresponding position, which may be, for example, a character, figure, or image. Alternatively, the information can be converted to other elements to be drawn, and merged with the existing data. Alternatively, the information can be pasted as an additional element, so-called annotation, which is often represented on a different layer from the layer that the elements to draw are rendered from the original electronic document.

Meanwhile, the embedding section 23A assigns respective IDs to the English words to be tagged with embedded information, as described above. The embedding section 23A sets mapping between information identifying an English word to be tagged, for example, the character string itself of the word and the ID assigned to the word and supplies the ID-to-word mapping information to the registering section 26A. The registering section 26A registers the ID-to-word mapping information on a database or the like for future reference (S19). The English word information registered in this manner can be used when the computerized English dictionary reference function is activated. If, for example, the character strings of English words are registered as English word information, automatic reference to the ID-to-word mapping information on the database or the like is performed with the ID key when an ID is detected from a document with embedded information, using a handy scanner or the like. Thus, the character string mapped to the ID as the information identifying the English word is retrieved. Then, automatic reference to a computerized English dictionary can be performed with the thus-retrieved character string key of the word, and the definition of the word will be returned.

If command strings to execute a computerized English dictionary reference program are included as information facilitating identifying words in the ID-to-word mapping information, computerized English dictionary reference can be performed more easily and automatically. The following method may, for example, be employed: detect an ID from a document with embedded information, search the database for the ID, retrieve the command string associated with the ID, and pass the retrieved command string as an argument to the shell program on the personal computer PC.

Similarly, a URL string can be registered as information facilitating identifying words, included in the ID-to-word mapping information. If the resource identified by the URL string (reference information in a broader sense) has a computerized English dictionary reference function, a computerized English dictionary reference can be performed using the following method: detect an ID with a handy scanner or the like, retrieve the URL string associated with the ID from the database, pass the URL string as an argument to the Web browser, then the Web browser accesses and opens the resource. This example of registering an URL string can be regarded as application of the suite of programmed functions shown in FIG. 7.

In some instances in which the invention can be implemented, it may be preferable to prepare beforehand a storage medium such as a CD-ROM having the ID-to-word mapping information stored thereon. In such a case, the embedding section 23A retrieves an ID mapped to an English word extracted to be tagged and performs the embedding related process. That is, in addition to the described embodiment in which IDs are generated and assigned to the words to be processed, the invention can be implemented in an embodiment in which IDs are retrieved from the storage medium. In this case, among the functions shown in FIG. 10, the registering section 26A is not necessary (a means for accessing the storage medium is required).

According to the preferred embodiments of the present invention, which focuses on page description languages in which the layout of elements rendered on a page has been well-defined, a process of rendering elements page by page from the document data described in a page description language, based on the layout information described in a page description language, a process of identifying an element and its region where information is to be embedded, and a process of embedding (as well as a process of registering necessary information) is performed, such that document data described in a page description language with embedded reference information or information identifying words is obtained. This document data can be printed by an ordinary printer. When the document data is printed, it is rendered so that embedded information and its surrounding are visually seamless, and, consequently, printed documents in which reference information or information identifying words was embedded and which do not give the user impression that something was pasted to the original are obtained. By reading the reference information or information identifying words with a handy scanner or the like and opening the information using an application, such as a web browser, Acrobat reader, or a computerized dictionary, the resources on the network and or in the computerized dictionary can be immediately accessed.

What is claimed is:

1. A document manipulation apparatus which embeds additional information in document data in which layout and position of a element have been defined, said apparatus comprising:
means for generating rendered image data by rendering a regions where additional information is to be embedded in the document data:
means for embedding additional information in a portion of the rendered image data; and
means for merging an image of the portion in which the additional information embedded in the rendered image data with a predetermined region in original document data.

2. A document manipulation apparatus according to claim 1, further comprising means for generating information that defines the layout and position of said element, wherein document data in which the layout and position of a element is not defined is converted to the document data in which the layout and position of a element have been defined, and then embedding of additional information is performed.

3. A document manipulation apparatus according to claim 1, wherein said element is an element linked to related information by reference information and said additional information pertains to said reference information or related information.

4. A document manipulation apparatus according to claim 1, wherein said element is a word included in document data and said additional information is information identifying the word to be looked up in a dictionary.

5. A method for document manipulation which embeds additional information in document data in which layout and position of a element have been defined, said method comprising:
a step of generating rendered image data by rendering a region where additional information is to be embedded in the document:
a step of embedding additional information in a portion of the rendered image data; and
a step of merging a images of the portion in which the additional information embedded in the rendered image data with a predetermined region in the original document data.

6. A method for document manipulation according to claim 5, further comprising a step of generating information that defines the layout and position of said element, wherein document data in which the layout and position of a element is not defined is converted to the document data in which the layout and positioning of a element have been defined, and then embedding of additional information is performed.

7. A method for document manipulation according to claim 5, wherein said additional information is embedded in the element associated with said additional information in the rendering image data and the embedded information are merged as the image in the original document data in the corresponding positions in accordance with the layout and position of the element.

8. A computer program product for document manipulation for embedding additional information in document data in which layout and position of a element have been defined, which, when executed by a computer, causes the computer to perform:
a step of generating rendered image data by rendering a region where additional information is to be embedded in the document:
a step of embedding additional information in a portion of the rendered image data; and
a step of merging an image of the portion in which the additional information embedded in the rendered image data with a predetermined region in a original document data.
